(19) United States
(12) Patent Application Publication
(10) Pub. No.: US 2013/0312590 A1
(43) Pub. Date: Nov. 28, 2013

(54) Electromagnetic Cymbal Pickup

(71) Applicant: Julia D. Truchsess, Sandy Hook, CT (US)

(72) Inventor: Julia D. Truchsess, Sandy Hook, CT (US)

(73) Assignee: Avedis Zildjian Co., Norwell, MA (US)

(21) Appl. No.: 13/479,953

(22) Filed: May 24, 2012

(51) Int. Cl. G10H 3/14

(52) U.S. Cl. 84/725

(57) ABSTRACT

A cymbal vibration transducer system includes a cymbal and a cymbal pickup. The cymbal pickup has a ferromagnetic body affixed to the cymbal and is operable to vibrate with the cymbal. It also has a one or more pickup heads each operable to transduce the vibrations of the ferromagnetic body into electrical signals. A method for transducing cymbal vibrations includes vibrating a ferromagnetic body commensurately with cymbal vibrations, applying a first magnetic flux to the vibrating the ferromagnetic body, and detecting disruptions in a first electric signal resulting from vibrations of the ferromagnetic body in the first magnetic flux.

### TECHNICAL FIELD

The present disclosure relates generally to electronic musical instruments, and particularly to pickups operative to transduce cymbal vibrations to electrical signals.

### BACKGROUND

Cymbals have traditionally been an acoustic-only instrument. For live performance in large spaces or recording sessions, microphones are commonly used to pick up the cymbal sound for subsequent amplification and/or recording, but the desire is to remain faithful to the natural sound of the cymbals. Occasionally, a moderate post-processing effect such as reverb or equalization is applied to tailor the sound of the cymbal as required or desired.

The advent of electronic drum kits has naturally given rise to “electronic cymbals.” Like their drum counterparts, these devices are used as electronic “triggers,”—that is, the sound of the “cymbal” itself being struck is not amplified for listening or intended to be heard at all. The prior art “cymbal” (or more accurately, a plastic or plastic-covered replica of a cymbal) of this type is fabricated with a sensor, producing trigger signals that initiate playback of pre-recorded or canned “samples” of acoustic cymbals when struck. The “sound” of the electronic cymbal is changed by changing the sample(s) that are triggered by the sensor being struck. While this approach offers advantages of virtually silent operation and “authentic” pre-recorded cymbal sounds, it suffers greatly in “feel” and “expression.” Drummers are accustomed to the feel of “stick-on-metal” that an acoustic cymbal provides, and the very large range of sound variation achievable by striking an acoustic cymbal in different locations with varying types of strikes, strike force, and striking objects (sticks, mallets, brushes, etc.). Practical, cost-effective sensing schemes are not available for providing the feel and range of expression that drummers are accustomed to with acoustic cymbals.

When, alternatively, a conventional microphone that responds to sound waves emanating from the vibrating cymbal is used, acoustic feedback and acoustic crosstalk from other instruments and ambient noise that is within range of the microphone become problematic, particularly for musical performances that are conducted at all but the quietest sound volume levels.

### OVERVIEW

As described herein, cymbal vibration transducer system includes a cymbal and a cymbal pickup, with the cymbal pick up having a ferromagnetic body affixed to the cymbal and operable to vibrate with the cymbal, and having one or more pickup heads each operable to transduce the vibrations of the ferromagnetic body into electrical signals.

Also as described herein is a cymbal pickup that includes a ferromagnetic body coupleable to the cymbal to commensurately vibrate with vibrations of the cymbal, and a first pickup head operative to generate a first electrical signal indicative of vibrations of the ferromagnetic body.

Also described herein is a method for transducing cymbal vibrations. The method includes vibrating a ferromagnetic body commensurately with cymbal vibrations, applying a first magnetic flux to the vibrating the ferromagnetic body, and detecting disruptions in a first electric signal resulting from vibrations of the ferromagnetic body in the first magnetic flux.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a diagrammatical view of cymbal vibration transducer system which uses an electromagnetic pickup to detect vibrations in a cymbal;

FIG. 2 is a view of an arrangement in which a ferromagnetic patch is adhered to a cymbal;

FIG. 3 is a view in which the pickup is provided with two pickup heads configured to sense vibrations from the bell of a cymbal;

FIG. 3A shows the use of a bushing as the pickup mounting means

FIG. 4 is a bottom plan view of the pickup mount affixed to the underside of cymbal bell concentrically around center hole of the cymbal;

FIG. 5 is a side view of an arrangement showing the cymbal swing limit;

FIG. 6 is a circuit block diagram of an anti-phase connection;

FIG. 7 is a is a diagrammatic view of system including a controller used with multiple instruments; and

FIG. 8 is a view of an illumination arrangement used with a perforated cymbal.

### DESCRIPTION OF EXAMPLE EMBODIMENTS

Example embodiments are described herein in the context of an electromagnetic cymbal pickup. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

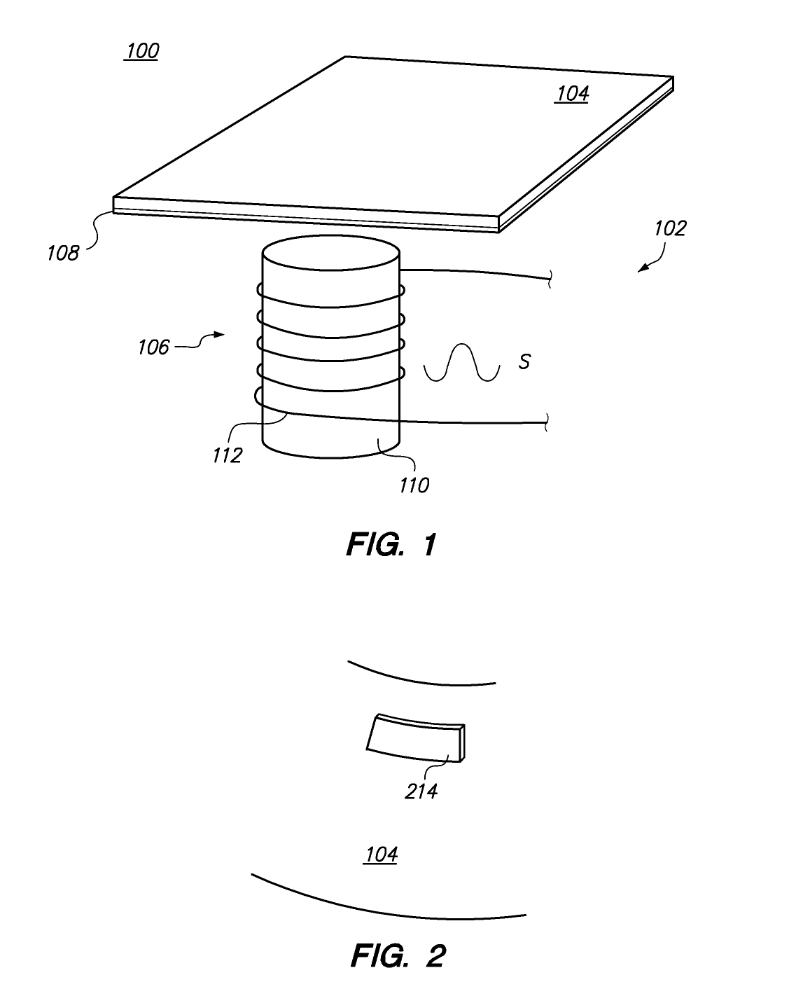

FIG. 1 is a diagrammatical view of a cymbal vibration transducer system 100 which uses an electromagnetic pickup 102 to detect vibrations in a cymbal 104. The pickup 102 includes a pickup head 106 in proximity to a ferromagnetic body 108 that is coupled to the cymbal for vibration therewith during operation—that is, when the cymbal is struck by a drumstick or otherwise made to vibrate, through crashing with another cymbal and the like. As the ferromagnetic body 108 vibrates in the vicinity of magnet 110, it causes disturbances in the magnetic flux field of the magnet. These disturbances induce an electrical current S in wire coil 112 that in this case is wrapped around the magnet. The current S closely correlates to the vibrations of the ferromagnetic body 108, and provides an indication of vibrational characteristics, such as magnitude and frequency, to downstream circuitry (not shown). This transduction process is non-destructive, in that there is no contact with vibrating ferromagnetic body 108 and therefore no impact on the vibrations being detected.

The ferromagnetic body 108 may be a coating applied to a portion of the cymbal 104, as in the configuration of FIG. 1. Alternatively, it may be a strip or patch adhered to the cymbal, or a more rigid component that is screwed, bolted, welded or otherwise firmly affixed to the cymbal. Such an arrangement is shown in FIG. 2, with a ferromagnetic patch 214 shown adhered to cymbal 104. In one embodiment, the ferromagnetic body is an integral portion of the cymbal, or it may be the entirety of the cymbal itself—that is, a cymbal made of ferromagnetic material.

High permeability for the ferromagnetic body 108 is preferred, and a nickel-iron alloy such as a Permalloy (in the range of 78% nickel-22% iron) is a good candidate. The addition of molybdenum and/or copper (Supermalloy) may improve permeability as desired. Sendust (iron, silicon, aluminum) is also a candidate material. Considerations such as good adhesion to the material of the cymbal, typically brass (copper-tin alloy) or nickel-platted brass, would be taken into account in a routine manner known to those of ordinary skill in the art. For the coating embodiment, methods of application of a ferromagnetic coating can include plasma deposition, plasma spray, flame spray, laser cladding, selective plating, and the like.

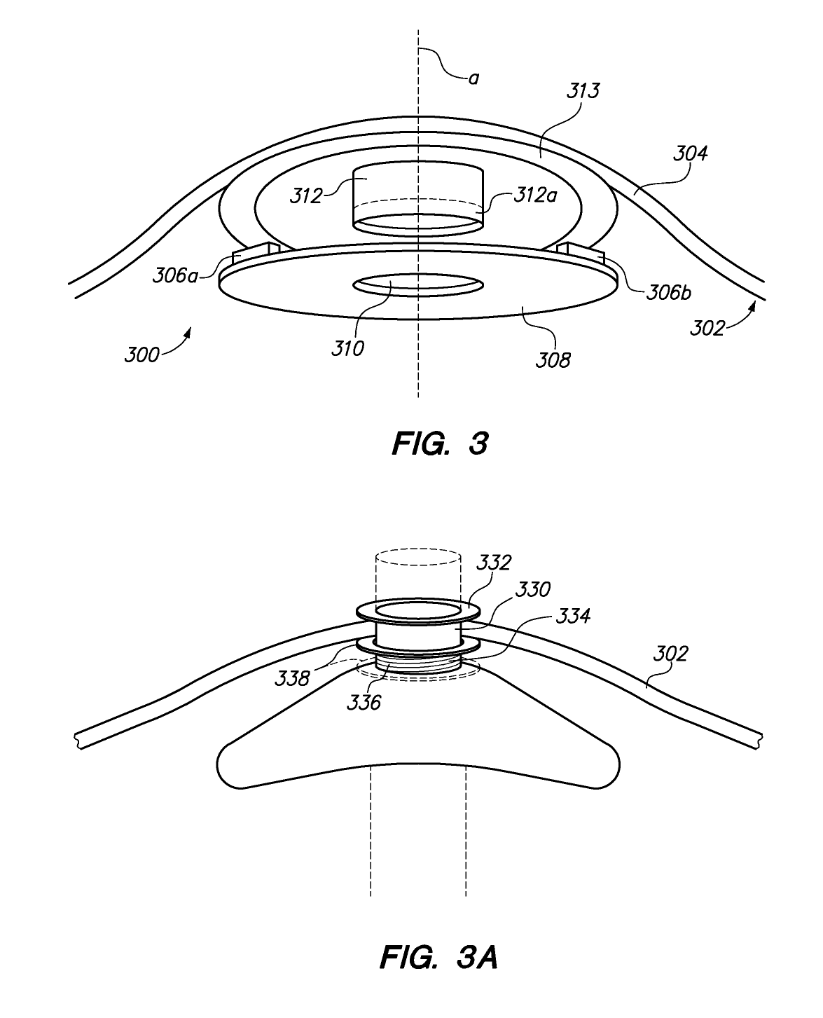

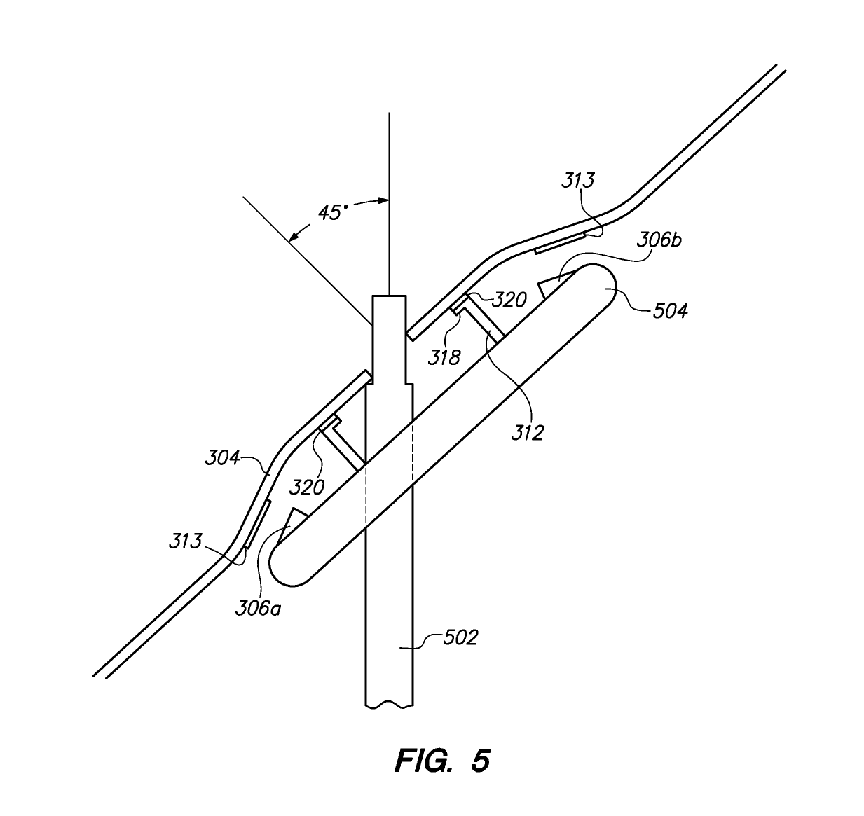

As explained above, the pickup comprises a pickup head disposed in confronting relationship to a ferromagnetic body that is coupled to the cymbal. In an embodiment shown in FIG. 3, the pickup is provided with two pickup heads, configured to sense vibrations from the bell of a cymbal, which is the innermost of the two major parts of the cymbal. Specifically, FIG. 3 shows a partial view of a pickup 300 mounted underneath a cymbal 302, to detect vibrations at cymbal bell 304. The pickup 300 is shown in partially disassembled form without a housing for clarity. The two pickup heads, designated 306a and 306b, are disposed on a circuit board 308, along with other electronics (not shown) used for sound processing and conditioning. Circuit board 308 is annular in shape and includes a central cut-out 310 for passage therethrough of a conventional cymbal stand shaft (502, FIG. 5) extending along the axis a and serving to support the cymbal. The circuit board 308, normally protected by the housing (504, FIG. 5), couples to a cylindrical pickup mount 312, either directly or by way of the housing or other component to thereby support the pickup heads 306a, 306b in confronting relationship to the ferromagnetic body 313. Pickup mount 312 may be threaded at 312a for this purpose, with the circuit board 308, housing, or other component threadingly mating with threads 312a to secure the remainder of the pickup 300 in place on the cymbal. Means of attachment other than threads—for example screws, fasteners, snaps, tabs, straps, adhesive and so on—are also contemplated. In one embodiment, a ¼-turn bayonet connection known in the art can be used.

Also contemplated is the use of a bushing as the pickup mounting means, in lieu of pickup mount 312. This is detailed in FIG. 3A, in which a bushing 330 is disposed in the central hole of the cymbal 302. The bushing 330 is provided with a flange 332 on one end, and threads 334 on the other, whereby it is retained in place in the cymbal hole when a portion 336 of the pickup housing is threaded onto threads 334 of the bushing. Spacers and/or washers 338, which may be of the isolating type (rubber, foam, etc.) may be used at various locations against the cymbal 302 to improve vibrational isolation.

Returning to FIG. 3, it shows ferromagnetic body 313, in this case a coating applied to the underside of bell 304, provided in confronting relationship to pickup heads 306a, 306b. The coating takes a substantially annular form, concentric around the cymbal center hole, in order to ensure alignment at any rotational position. This facilitates assembly of the pickup, when the components are threaded onto pickup mount 312, and enables a modular construction that is readily disassembled for ease of transport and then reassembled for normal operation. In this modular arrangement, the pickup mount 312 can remain affixed to the cymbal, and the housing, along with the circuit board and electronics and other components, would be removable (by unthreading for example) from the pickup mount 312 for easy storage and transport.

When assembled and in the operative configuration, the pickup heads 306a, 306b should be spaced about ¼ inch from the ferromagnetic body 313. This distance of course can vary depending on the permeability of the ferromagnetic material selected, sensitivity of the pickup heads, and personal preference of the user. For purposes of user preference, the distance may be adjustable by the user to achieved desired sound characteristics, and such adjustment may be effected by controlling the extent of the threading engagement—that is, how many turns are executed—between the pickup mount 312 and the housing or circuit board to which the pickups are attached. Other adjustment mechanisms are also contemplated.

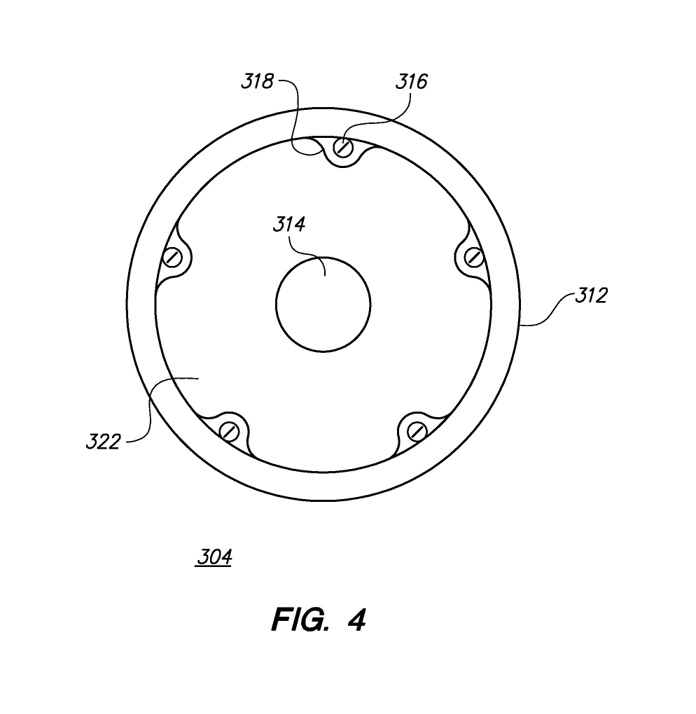

FIG. 4 is a bottom plan view of the pickup mount 312 affixed to the underside of cymbal bell 304 concentrically around center hole 314 of the cymbal. Five evenly-spaced screws 316 pass through flanges 318 formed in the pickup mount to secure the pickup mount 312 to the bell of the cymbal. A different number of screws, or other fastening means, such as rivets, welds, and the like, are also contemplated. In one embodiment, isolating washers 320 (FIG. 5), for example made of rubber or foam, can be placed between the flanges 318 and the cymbal to reduce the transfer of vibrations from the cymbal to the pickup.

Pickup mount 312 has an open tubular interior portion 322, with an inner diameter that is larger than the diameter of center hole 314, in order to minimize interference with the swing of the cymbal during operation. This geometry is best illustrated in FIG. 5, and allows a cymbal swing around stand shaft 502 of about 30 to 45 degrees or more without interference from pickup 300. A swing angle in this range can be achieved using a pickup mount height of about ½ inch, and inner diameter of about 2.2 inches. Of course other dimensions are also contemplated. Also illustrated in FIG. 5 is housing 504, which contains the electronic components of the pickup, along with pickup heads 306a, 306b shown protruding from the housing towards annular ferromagnetic coating 313.

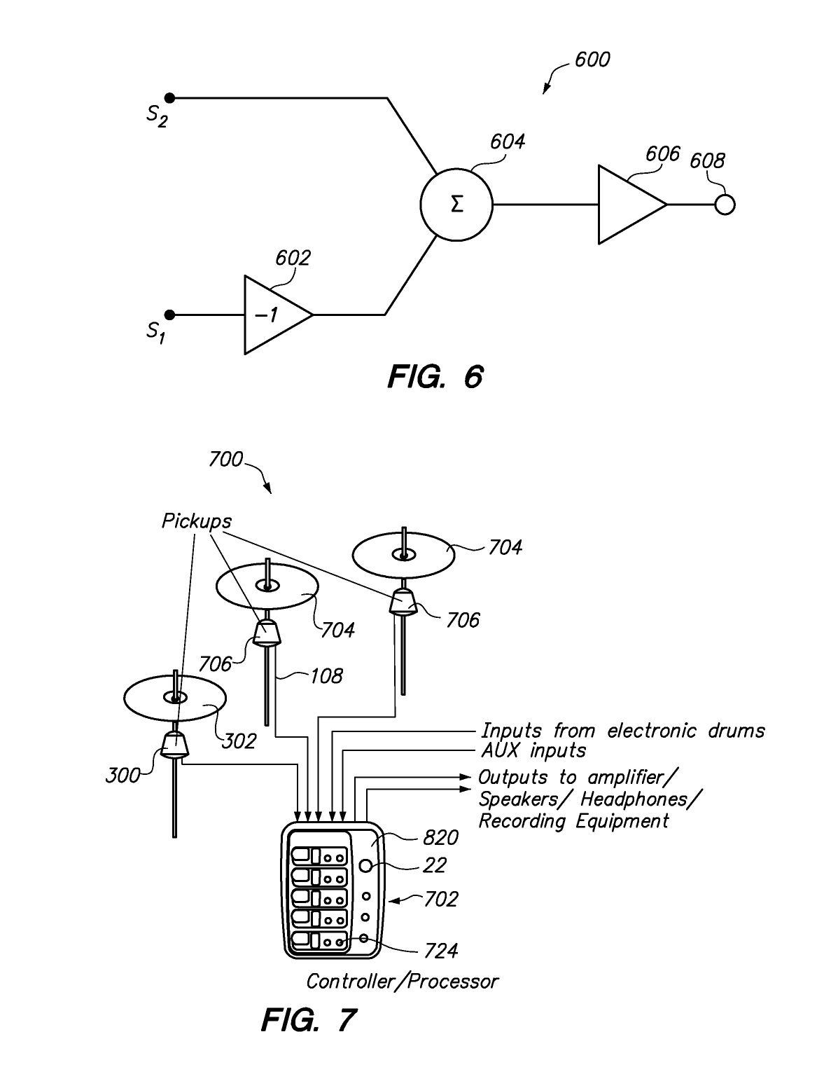

FIG. 6 is a block diagram of optional signal conditioning circuitry 600 used in what will be referred to herein as a phase-inverting configuration. In the phase-inverting configuration, also referred to as an out-of-phase or anti-phase connection, the phase of one of the signals S₁ (from head 306a or 306b) is inverted prior to combining with the other signal S₂. The inversion is implemented using an inverter 602. Alternatively, signal inversion can be achieved using oppositely-wound coils in the pickup heads, or by reversing the connection polarity of similarly-wound coils. Phase inversion can alter and improve the resultant sound quality of the combined output signal. The out-of-phase connection operates to cancel signals which are in phase with one another and augment signals that are out of phase with one another. The scheme, along with a suitable arrangement of pickup heads (for example 180-degrees apart) and placement of the pickup, exploits the fact that in some cases the more desirable components of the cymbal's vibration are out of phase with each other, whereas the less-desirable components are in phase with each other. An advantage of the phase-inverting configuration is AC mains hum field cancellation. In the field of electric guitar pickups, this is also known as “humbucking”. The coils of the pickup heads pick up AC fields even without magnets, and if two identical coils are connected out of phase the AC hum will cancel. Further, if the magnets of the two coils are reversed in polarity, the double-inversion results in twice as much transduced vibration. In one embody, one of the coils is used as a “dummy” without a magnet, serving only to cancel hum and not to transduce any vibration.

Returning to the configuration of FIG. 6, after the inversion of one of the signals, the two signals are combined in a summation block 604, using techniques well-known to those skilled in the art. The combined signals are then buffered by buffer amplifier 606 in order to present a low impedance output at output node 608. This output node can be provided at an output jack (not shown) of pickup 300 as an output of the pickup. Alternatively or in addition, it can be connected to other processing circuitry in the pickup, such as that described below. Thus the conditioning, including the phase inversion and summation, can be performed either internally, in circuits or software modules disposed within pickup 300, or externally using other circuits, devices or software modules. Further, it can be performed in the analog or digital domains, or in a combination of these depending on design choice. Further, to facilitate some external conditioning processes, the two (or more) signal S₁, S₂ outputs can also be independently made available to external circuitry.

In a more generalized application, described with reference to system 700 shown in FIG. 7, a controller 702 is coupled to multiple pickups, at least one of which is magnetic pickup 300, while others, usable with the same (302) or other (704) cymbals, can be any of a variety of known microphones 706. The cymbals 302, 804 can be any known metallic (or other percussive material) instruments, in the form of hi-hat, ride or crash cymbals, which undergo vibrations when struck by an object such as a drumstick, mallet or the like, or collided into each other. Further, in the embodiment of FIG. 7, the cymbals are of the known perforated variety, with multiple holes provided therein order to reduce or otherwise alter their sound output, for example for quieter, non-performance settings.

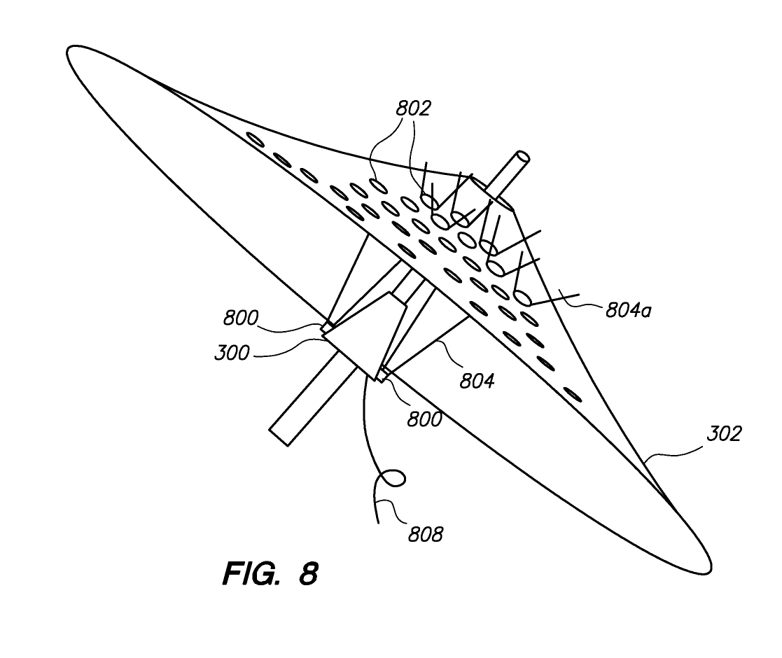

Controller 702 also operates to manage the operation of light sources such as LEDs 800 shown in FIG. 8 provided on pickup 300 for aesthetic purposes. The light sources illuminate the underside of cymbal 302, and pass light through the perforations 802 provided therein. The light is designated 804 and 804a. The illumination operation can for example be synchronized to various rhythms or beats processed by controller 702 connected by way of cable 808, or wirelessly.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

1. A cymbal vibration transducer system comprising:
a cymbal; and
a cymbal pick up including:
a ferromagnetic body affixed to the cymbal and operable to vibrate with the cymbal; and
one or more pickup heads each operable to transduce the vibrations of the ferromagnetic body into electrical signals.

2. The cymbal vibration transducer system of claim 1, wherein the ferromagnetic body is a coating applied to at least a portion of the cymbal.

3. The cymbal vibration transducer system of claim 1, wherein the ferromagnetic body is a strip or patch that is adhered to the cymbal.

4. The cymbal vibration transducer system of claim 1, wherein the ferromagnetic body is a rigid component that is secured to the cymbal using one or more of screws, bolts, welds or a combination thereof.

5. The cymbal vibration transducer system of claim 1, wherein the ferromagnetic body is formed integrally with the cymbal.

6. The cymbal vibration transducer system of claim 1, wherein the ferromagnetic body comprises a nickel-iron alloy.

7. The cymbal vibration transducer system of claim 6, wherein the ferromagnetic body further comprises molybdenum and/or copper.

8. The cymbal vibration transducer system of claim 1, wherein the ferromagnetic body includes one or more of iron, silicon and aluminum.

9. The cymbal vibration transducer system of claim 1, wherein the pickup includes two pick up heads having an anti-phase configuration.

10. The cymbal vibration transducer system of claim 9, wherein the first of the two pickup heads includes a permanent magnet and a coil wound in a first direction, and the second of the two pickup heads includes a permanent magnet and a coil wound in a second direction.

11. The cymbal vibration transducer system of claim 9, wherein the first and second directions are different.

12. The cymbal vibration transducer system of claim 9, wherein only one of the two pickup heads is provided with a magnet.

13. The cymbal vibration transducer of claim 1, further including a pickup mount affixed to the cymbal and configured to support the one or more pickup heads in confronting relationship to the ferromagnetic body.

14. The cymbal vibration transducer of claim 13, wherein the support is adjustable.

15. The cymbal vibration transducer system of claim 13, wherein the pickup mount is detachable from other components supporting the one or more pickup heads.

16. The cymbal vibration transducer system of claim 13, wherein the pickup mount includes attachment means for coupling other components supporting the one or more pickup heads.

17. The cymbal vibration transducer system of claim 13, wherein the pickup mount is about ½ inch in height.

18. The cymbal vibration transducer system of claim 13, wherein the pickup mount is about 2.2 inches in diameter.

19. The cymbal vibration transducer system of claim 17, wherein the pickup mount is about 2.2 inches in diameter.

20. The cymbal vibration transducer system of claim 1, further including a bushing configured to seat in a central hole of the cymbal and to support the one or more pickup heads in confronting relationship to the ferromagnetic body.

21. The cymbal vibration transducer system of claim 1, wherein the pickup includes one or more light sources.

22. A cymbal pickup comprising:
a ferromagnetic body coupleable to the cymbal to commensurately vibrate with vibrations of the cymbal; and
a first pickup head operative to generate a first electrical signal indicative of vibrations of the ferromagnetic body.

23. The cymbal pickup of claim 22, wherein the ferromagnetic body is a strip or patch that is adhered to the cymbal.

24. The cymbal pickup of claim 22, wherein the ferromagnetic body is a rigid component that is secured to the cymbal using screws, bolts or welds.

25. The cymbal pickup of claim 22, wherein the ferromagnetic body comprises a nickel-iron alloy.

26. The cymbal pickup of claim 22, wherein the ferromagnetic body further comprises molybdenum and/or copper.

27. The cymbal pickup of claim 22, wherein the ferromagnetic body includes one or more of iron, silicon and aluminum.

28. The cymbal pickup of claim 22, further including a second pickup head operative to generate a second electrical signal indicative of vibrations of the ferromagnetic body.

29. The cymbal pickup of claim 28, wherein the first and second pickup heads are arranged in an anti-phase relationship.

30. The cymbal pickup of claim 29, wherein the anti-phase relationship is achieved using an inverter coupled to one of the first or second electrical signals.

31. The cymbal pickup of claim 29, wherein the anti-phase relationship is achieved using pickup heads having oppositely-wound coils.

32. The cymbal pickup of claim 29, wherein the anti-phase relationship is achieved using oppositely-connected pickup heads.

33. The cymbal pickup of claim 22, further including a pickup mount affixable to the cymbal and configured to support the pickup head in confronting relationship to the ferromagnetic body.

34. The cymbal pickup of claim 33, wherein the support is adjustable.

35. The cymbal pickup of claim 33, wherein the pickup mount is detachable from other components supporting the one or more pickup heads.

36. The cymbal pickup of claim 33, wherein the pickup mount includes attachment means for coupling other components supporting the one or more pickup heads.

37. The cymbal pickup of claim 33, wherein the pickup mount is about ½ inch in height.

38. The cymbal pickup of claim 33, wherein the pickup mount is about 2.2 inches in diameter.

39. The cymbal pickup of claim 22, further including a bushing configured to seat in a central hole of the cymbal and to support the one or more pickup heads in confronting relationship to the ferromagnetic body.

40. The cymbal pickup of claim 22, wherein the pickup includes one or more light sources.

41. A method for transducing cymbal vibrations comprising:
vibrating a ferromagnetic body commensurately with cymbal vibrations;
applying a first magnetic flux to the vibrating the ferromagnetic body; and
detecting disruptions in a first electric signal resulting from vibrations of the ferromagnetic body in the first magnetic flux.

42. The method of claim 41, further comprising applying a second magnetic flux to the vibrating the ferromagnetic body and detecting disruptions in a second electric signal resulting from vibrations of the ferromagnetic body in the first magnetic flux.

43. The method of claim 42, further comprising coupling the first and second electric signals in anti-phase configuration.

44. The method of claim 41, further comprising illuminating the cymbal.

45. The method of claim 41, wherein the ferromagnetic body is a portion of the cymbal, the cymbal being formed of a ferromagnetic material.

46. The cymbal vibration transducer system of claim 1, wherein the ferromagnetic body is a portion of the cymbal, the cymbal being formed of a ferromagnetic material.
